(19) United States
(12) Patent Application Publication
(10) Pub. No.: US 2010/0186760 A1
(43) Pub. Date: Jul. 29, 2010

(54) Revolving knife disc, a method of mounting the revolving knife disc and a method of removing the revolving knife disc

(76) Inventor: Marek Sieredzinski, Radom (PL)

Correspondence Address: NIXON & VANDERHYE, PC, 901 NORTH GLEBE ROAD, 11TH FLOOR, ARLINGTON, VA, 22203, US

(21) Appl. No.: 12/654,910

(22) Filed: Jan. 8, 2010

(30) Foreign Application Priority Data
Jan. 13, 2009 (PL) PLP-387023

(51) Int. Cl. A24C 5/34; B23P 11/02

(52) U.S. Cl. 131/280; 29/450; 29/426.6

(57) ABSTRACT

A rotating disc knife, in particular for cutting the paper cover of cigarettes, provided with a mounting opening for mounting the knife onto a cutting assembly shaft and with a plurality of cutting teeth (1, 2) located around the circumference of the disc (6), wherein the mounting opening (7) in the disc (6) of the knife connects with the cutting edge (5) of the disc at a point (8) where the edge (5) of the knife is discontinuous.

A method of mounting/dismounting a rotating disc knife provided with a mounting opening onto/from a cutting assembly shaft provided with a plurality of such disc knives.

The object of the invention is a rotating disc knife, particularly for cutting the paper cover of cigarettes.

Moreover, the object of the invention is a method of mounting the rotating disc knife onto a cutting assembly shaft, and a method of dismounting the rotating disc knife from the shaft of such an assembly.

Rotating disc knives are used in the process of cigarettes production in order to recycle tobacco from the cigarettes which have been damaged or rejected from the production process as sub-standard and/or defective; they are designed for cutting or perforating the paper cover of the cigarettes.

In the case of cutting non-filter cigarettes, the paper cover is cut along the whole length of a cigarette. In the case of filter cigarettes, the paper cover should only be cut along the tobacco portion, while the filter portion paper cover wrapping the filter must remain unimpaired. The task faced by design engineers is to design a device for recycling tobacco operating in such a way that cigarette paper and all the fragments or components of the filtering material are separated from tobacco. Recycled tobacco is added to shreded tobacco fed to cigarette making machines. The quality of cigarettes is significantly lowered if the tobacco used for the production contains particles of filtering material, since the smoke from burnt filtering material can be harmful to a smoker. Currently produced cigarettes are provided with multi segment filters containing filtering materials of various types. Materials in the form of granules are also used, e.g. activated carbon enclosed in a multi segment filter between other fragments, such as for example acetate filter, which form a chamber for loose material. Cutting such a filter is particularly disadvantageous since separation of granules which are significantly smaller than tobacco shreds requires application of special cleaning assemblies.

In the devices used for tobacco recycling, disc knives are mounted on a cutting assembly shaft, on which there is a plurality of such knives arranged in sequence next to one another.

### PRIOR ART

Known devices for cutting cigarette paper cover were disclosed for example in the following documents: U.S. Pat. No. 3,665,931, U.S. Pat. No. 5,318,048 and EP 0 333 280.

In these known devices, e.g. according to U.S. Pat. No. 3,665,931, cigarettes are delivered by a feeder to a first linear vibrating conveyor, and then, after having been oriented parallel to the conveying direction, they are conveyed by a second linear vibrating conveyor belt towards a damping assembly and a cutting assembly. In the cutting assembly, a disc knife provided with a plurality of small blades is placed above every flute, the knife cutting the wetted cigarettes lengthwise. The cigarettes with perforated paper cover fall on a vibrating conveyor, where a part of tobacco is separated, and then they are fed to a so called “opener” assembly, where the pre-cut paper covers pass between revolving rollers provided with a plurality of perpendicularly oriented rods, causing the rest of the tobacco to be removed. During all these operations the tobacco from the cigarette is separated from the paper covers. The distance between the knife and the vibrating conveyor belt is adjusted in such way, that the wrapper covering the filter tip is not cut.

In a similar device disclosed in U.S. Pat. No. 5,318,048 a toothed disc knife located above the conveyor belt revolves at a velocity synchronized with that of the conveyor, owing to which the paper covers of cigarettes are perforated and the cigarettes are further conveyed to the other assemblies in order to separate the tobacco from the cigarette covers. The distance between the knife and the conveyor belt is so adjusted that the filter is deformed while passing under the knife, but the wrapper covering the filter tip is not perforated.

In the device known from EP 0 333 280, the cigarettes from which the tobacco is to be recycled are conveyed by vibrating conveyors to a cutting assembly. The axes of the cigarettes are oriented along the conveying direction on the linear vibrating conveyors and then placed in flutes on a fluted drum so that they are directed tangential to the circumference of the drum. Above the drum a cutting assembly is located provided with a plurality of disc knives mounted on a shaft in such a way that one knife is located above each flute of the fluted drum. These knives cut the cigarettes lengthwise. The distance between the knife and the drum is adjusted in such way, that the knife causes deformation of the cigarette filter without cutting the paper wrapper on the filter.

A disadvantage of the known devices is the problem of replacement of defective or worn-out knife discs which usually need to be replaced individually. In the case of known disc knives, replacement of a knife which requires removing it and then mounting a new knife involves dismounting from the shaft at least all of the knives which are fitted on the shaft on one side of the knife being replaced. Sometimes, it is even necessary to remove the shaft from the machine together with the knives, and the replacement of the knife takes place outside of the machine. This process is troublesome and time-consuming.

In the known devices, apart from the described problems posed by replacement of the knives, tobacco particles are not removed from open cigarettes, since during the first phase of the process the paper cover is not cut, and it is not completely torn apart until the next phases. As it usually happens, it will not be completely torn apart at all.

The serrated knives which have been used so far perforate the paper cover, which must be further torn apart. The paper cover may be torn apart in such a way, that the particles of the paper cover can be detached and may get into the recycled tobacco, which is harmful to the quality of the recycled tobacco. If the knife is damaged, e.g. when a part of a tooth of the knife is broken, the cigarette paper cover is perforated only partially or is not perforated at all. As a result, the tobacco from part of the cigarettes will not be recycled. In practice, with this type of cutting assemblies individual knives are usually damaged, since hard objects, such as pieces of wood, plastic or metal can, accidentally and unnoticed by the operator, get into the containers in which damaged and defective cigarettes are collected. Such objects of the size close to the size of a cigarette may damage individual knives.

Moreover, the known toothed disc knives pierce the cigarette while perforating the cigarette paper cover, which may cause the cigarette to catch a tooth so strong that the cigarette is lifted from the fluted drum. In such a case flip-off discs located on both sides of the knife are necessary to push the caught cigarette away from it.

To solve the aforementioned problems of the prior art, a rotating disc knife was designed in two embodiements, as well as a method of mounting it onto a cutting assembly shaft and dismounting it from the shaft.

### SUMMARY OF THE INVENTION

A rotating disc knife, in particular for cutting the paper cover of cigarettes, provided with a mounting opening for mounting the disc knife onto the cutting assembly shaft, and a plurality of cutting teeth around the circumference of the disc, according to invention is characterized in that the mounting opening located in the disc of the knife connects with the cutting edge of the knife at a point where the edge of the knife is discontinuous.

Advantageously, the knife is made of elastically deformable material and drawing its free endings apart to a distance equal at least to the diameter of the cutting assembly shaft constitutes elastic deformation.

Preferably, the shape of the mounting opening is a combination of a circle and a triangle.

The disc of the knife advantageously comprises two half-discs, having equal number of teeth, one of the half-discs is provided around its circumference with teeth located on one side of the middle plane of the disc, the middle plane being parallel to the surface of the disc, while the second half-disc is provided with teeth located on the opposite side of said middle plane, both half-discs being detachably connected to each other over said middle plane.

The radial axes of all the teeth are advantageously spaced by equal angular distances.

The revolving knife, in particular for cutting the paper cover of cigarettes, according to another aspect of the invention, is provided with a mounting opening for mounting the disc knife on a cutting assembly shaft, and with a plurality of cutting teeth around the circumference of the disc, and is characterized in that the mounting opening connects with the edge of the knife at a point where the edge of the knife is discontinuous and in that each two consecutive teeth are located on opposite sides of the middle plane of the disc, said middle plane being parallel to the disc, and each tooth having an inner and outer wall which are convergent towards the outer cutting edge of the disc, while the inner walls of all the teeth lie over said middle plane.

Advantageously, outer walls of the teeth located on both sides of said middle plane are inclined at the same angle to the plane.

The disc advantageously consists of two half-discs, both having equal number of teeth, one of half-discs is provided around its circumference with teeth located on one side of the middle plane of the disc, said middle plane being parallel to the surface of the disc, while the second half-disc is provided with teeth located on the opposite side of said middle plane, both half-discs being detachably connected to each other over said middle plane.

The radial axes of all the teeth are advantageously spaced by equal angular distances.

Advantageously, the disc knife is made of elastically deformable material.

According to the invention a method of mounting a rotating disc knife provided with a mounting opening, onto the cutting assembly shaft provided with a plurality of such knives, is characterized in that the knife is mounted without dismounting the adjacent knives, the free endings of the knife being drawn apart at the point where the cutting edge of the disc is discontinuous, to a distance equal at least to the diameter of the cutting assembly shaft, then the knife is slid onto the shaft in the direction essentially perpendicular to the axis of the shaft, and the knife is positioned perpendicularly to the axis of the shaft and the free endings of the disc are drawn back into the same plane.

According to the invention a method of dismounting the rotating disc knife provided with a mounting opening, from the cutting assembly shaft, provided with a plurality of such knives, is characterized in that the knife is dismounted from the shaft without dismounting the adjacent knives, the free endings of the knife being drawn apart at the point where the cutting edge of the disc is discontinuous, to a distance equal at least to the diameter of the cutting assembly shaft, and the knife is dismounted from the shaft in the direction essentially perpendicular to the axis of the shaft.

The rotating disc knife according to the invention enables mounting and dismounting individual knives onto and from the cutting assembly shaft without the necessity of dismounting the remaining knives and without the necessity of removing the shaft from the machine.

Moreover, the rotating disc knife according to the invention enables cutting the paper cover along the whole tobacco portion of a cigarette (outside the filter) and leaves the cigarette paper cover open along said whole part without the necessity of performing additional operations on the paper cover in order to facilitate removal of tobacco. Such a knife makes the time required for the removal of the tobacco on the vibrating sieve conveyor shorter, and furthermore, it is not necessary to use a so called “opener” assembly any more.

Linear slitting of the paper cover along the whole tobacco portion with the use of the disc knife according to the invention eliminates the risk of tearing apart fragments of the paper cover during the whole process of tobacco recycling; the paper cover is slit and pushed to sides, owing to which the cigarette is not caught by the disc knife and is not lifted from the fluted drum.

The main characteristic of the invention is a combination of the saw-shaped perforating blade with the features of a flat, continuously cutting disc knife with a sharpened edge. This combination results in a straight line of slitting the cigarette while the knife is only slightly immersed into the product being slit.

Moreover, after cutting, the knife acts as a wedge pushing the cut edges to sides and enhancing the opening of a cigarette.

The advantage of the knife and the method of cutting the paper cover according to the invention is also that the specific arrangement of teeth on both sides of the middle plane of the disc, their concentration and the special inclination of their walls result in that the impact necessary for cutting the cigarette is smaller than in the case of traditional knives, and in that perforation and cutting of harder parts of the cigarette, e.g. its filter is prevented.

### SHORT DESCRIPTION OF THE DRAWING

The rotating disc knife according to the invention is shown as an exemplary embodiment in the drawing, where:

FIG. 1 shows a projection of the knife according to the invention onto a plane parallel to the disc;

FIG. 2 shows a perspective view of the knife according to the invention after the free endings of the cutting edge have been drawn apart;

FIG. 3 shows a perspective view of the knife according to the invention before mounting it onto a cutting assembly shaft or after it has been dismounted from the shaft;

FIG. 4 shows the knife according to the invention mounted on a shaft, with the free endings of the cutting edge drawn apart;

FIG. 5 shows the knife according to the invention mounted on a shaft, with the cutting edges connected;

FIG. 6 shows a projection of the knife according to the invention onto a plane parallel to the disc and an enlarged, detailed view of the teeth;

FIG. 7 shows a sectional view of the disc knife along the plane perpendicular to the disc, extending across the centre of the disc, and an enlarged, detailed view of the teeth.

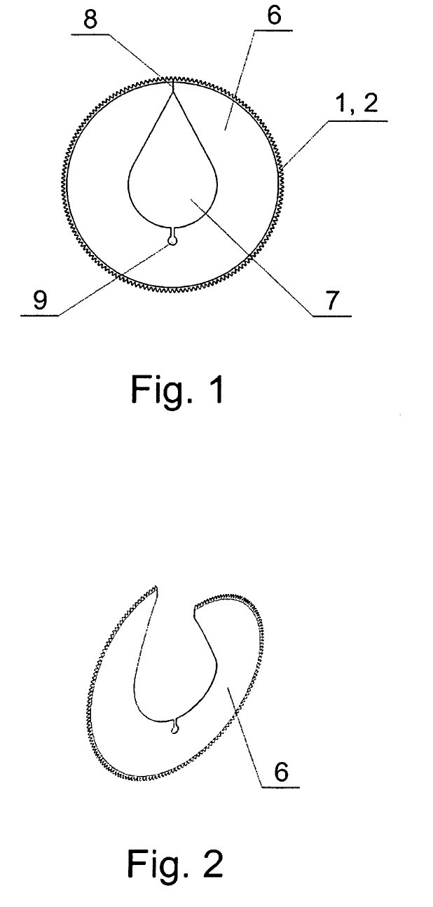

FIG. 1 shows a projection of the knife according to the invention onto a plane parallel to its disc 6. Teeth 1, 2 are located on the circumference of the disc 6. The disc knife has an opening 7; in this case the opening 7 is drop-shaped, although the shape of the opening may be different. The opening 7 connects with the cutting edge 5 of the knife at a point 8 where said edge is discontinuous. Opposite the point 8 an additional cut-out 9 may be made.

FIG. 2 shows a perspective view of the knife according to the invention after the free endings of the cutting edge 5 have been drawn apart in order to mount the knife onto the cutting assembly shaft or to dismount it from the shaft.

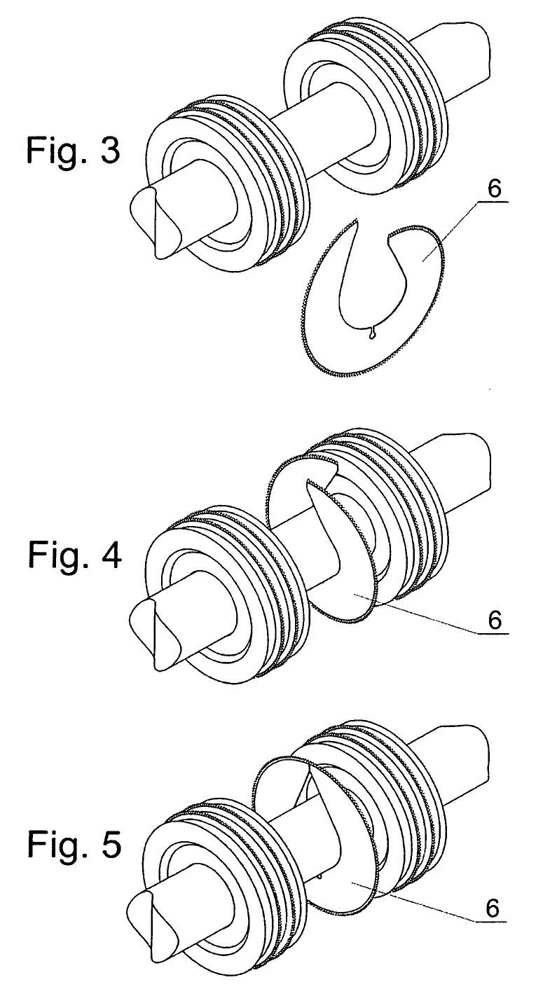

FIGS. 3-5 show the consecutive phases of the replacement of the knife. Thus, in order to replace a damaged knife it is sufficient to:

loosen the means attaching the knives to the shaft;

slide the knives apart so that there is a free space near the damaged knife, making it possible to mount and dismount a knife;

draw the free endings of the cutting edge of the damaged knife apart at point 8 and slide it out perpendicularly to the axis of the shaft;

draw the free endings of the cutting edge 5 of a new knife apart and slide it onto the shaft perpendicularly to the axis of the shaft;

slide all the knives back to their original positions;

block the knives on the shaft.

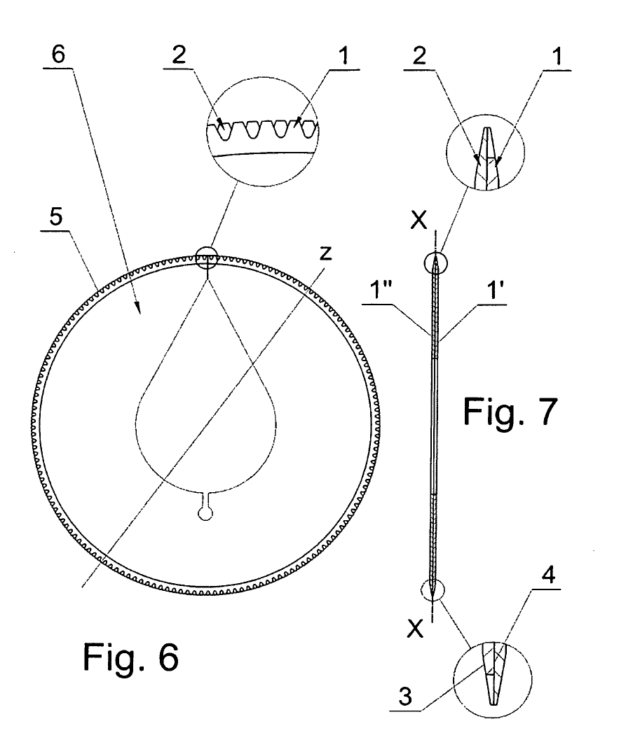

FIG. 6 shows a projection of the knife according to the invention onto the plane parallel to the knife and an enlarged, detailed view of the teeth. Teeth 1, 2 are located around the circumference of the disc 6, the inner walls 4 of the teeth which lie over the middle plane X-X of the disc 6, the outer walls 3 thereof being inclined and convergent towards the cutting edge 5 of the disc 6. An enlarged fragment of the edge 5 with the teeth 1, 2 has been circled.

FIG. 7 shows a sectional view of the knife over the plane X-X perpendicular to the knife disc 6, and extending across the centre of the disc 6. Two enlarged fragments of the cutting edge 5 with the teeth 1, 2, having inner walls 4 lying over the plane X-X and outer walls 3, convergent towards the edge 5 are shown within the circles.

A knife according to the invention operates in the following manner. In the first phase of cutting cigarette paper, the knife teeth press a cigarette causing multi-point pre-cut of the paper—the cutting constitutes a multi-point perforation caused by the sharpened heads of the teeth. Next, the teeth immersing deeper into a cigarette, cut the paper cover in a way resembling cutting with a knife. While immersing deeper into the cigarette, the cutting edges of two adjacent knives converge, cutting the paper cover completely in a way resembling cutting with scissors. There is no movement of the cutting edges against each other as it happens in the case of scissors, but this mutual movement is replaced by the movement of the cutting edges against the paper cover perpendicularly to the paper cover, which causes the cutting as well. More importantly, at the same time, side walls of the teeth of the knife disc are positioned at an angle to the middle plane of the disc causing the cut edges of the paper cover to be drawn apart.

1. A rotating disc knife, in particular for cutting the paper cover of cigarettes, provided with a mounting opening for mounting the knife onto a cutting assembly shaft, and a plurality of cutting teeth around the circumference of the disc, characterized in that the mounting opening (7) located within the disc (6) of the knife connects with the cutting edge (5) of the knife which is discontinuous at the point of connection (8).

2. A rotating disc knife according to claim 1, characterized in that it is made of elastically deformable material.

3. A rotating disc knife according to claim 2, characterized in that drawing its free endings apart to a distance equal at least to the diameter of the cutting assembly shaft constitutes elastic deformation.

4. A rotating disc knife according to claim 1, characterized in that the mounting opening (7) has a shape being a combination of a circle and a triangle.

5. A rotating disc knife according to claim 1, characterized in that the disc comprises two half-discs (1′, 1″) having equal number of teeth, one of the half-discs is provided around its circumference with teeth (1) located on one side of the middle plane (X-X) of the disc (6), which is parallel to the disc, and the second half-disc is provided with teeth (2)located on the opposite side of said middle plane (X-X), the half-discs (1′, 1″) being detachably connected to each other over said middle plane (X-X).

6. A rotating disc knife according to claim 5, characterized in that the radial axes (Z) of all the teeth are spaced by equal angular distances.

7. A rotating disc knife, in particular for cutting the paper cover of cigarettes, provided with a mounting opening for mounting the knife onto a cutting assembly shaft and a plurality of cutting teeth around the circumference of the disc, characterized in that a mounting opening (7) connects with the cutting edge (5) of the knife which is discontinuous at the point of connection (8) and in that each two consecutive teeth (1, 2) are located on opposite sides of the middle plane (X-X) of the disc (6), which is parallel to the disc, each tooth having an inner wall (4) and an outer wall (3), which are convergent towards the outer cutting edge (5) of the disc (6), and the inner walls of all the teeth lying over said middle plane (X-X).

8. A rotating disc knife according to claim 7, characterized in that the outer walls (3) of the teeth located on both sides of said middle plane (X-X) are inclined to the plane (X-X) at the same angle.

9. A rotating disc knife according to claim 7, characterized in that the disc (6) comprises two half-discs (1′, 1″) having equal number of teeth, one of the half-discs is provided at its circumference with teeth (1) located on one side of the middle plane (X-X) of the disc (6), said middle plane being parallel to the surface of the disc, and the second half-disc is provided with teeth (2) located on the opposite side of said middle plane (X-X), the half-discs (1′, 1″) being detachably connected to each other over said middle plane (X-X).

10. A rotating disc knife according to claim 9, characterized in that the radial axes (Z) of all the teeth are spaced by equal angular distances.

11. A rotating disc knife according to claim 7, characterized in that it is made of elastically deformable material.

12. A method of mounting a rotating disc knife provided with a mounting opening onto a cutting assembly shaft provided with a plurality of such disc knives, characterized in that a knife is mounted without dismounting the adjacent knives, the free endings of the disc knife being drawn apart at the point where the cutting edge of the disc is discontinuous, to a distance equal at least to the diameter of the cutting assembly shaft, the disc knife is slid onto the shaft in the direction essentially perpendicular to the axis of the shaft, and then the knife is positioned perpendicularly to the axis of the shaft, thereafter the free endings of the knife are drawn back into the same plane.

13. A method of dismounting a rotating disc knife provided with a mounting opening from a cutting assembly shaft provided with a plurality of such disc knives, characterized in that a knife is dismounted from the shaft without dismounting adjacent knives, the free endings of the knife being drawn apart at the point where the cutting edge of the disc is discontinuous, to a distance equal at least to the diameter of the cutting assembly shaft, and the knife is dismounted from the shaft in the direction essentially perpendicular to the axis of the shaft.
